(19) United States
(12) Patent Application Publication
(10) Pub. No.: US 2016/0325256 A1
(43) Pub. Date: Nov. 10, 2016

(54) METHODS AND COMPOSITIONS FOR STIMULUS-CONTROLLED PERMEABILITY

(71) Applicants: Christoffer Karl Abrahamsson, Cambridge, MA (US); Michael Persson, Vastra Frolunda (SE)

(72) Inventors: Christoffer Karl Abrahamsson, Cambridge, MA (US); Michael Persson, Vastra Frolunda (SE)

(21) Appl. No.: 15/149,154

(22) Filed: May 8, 2016

Related U.S. Application Data
(60) Provisional application No. 62/159,147, filed on May 8, 2015.
(60) Provisional application No. 62/175,369, filed on Jun. 14, 2015.
(60) Provisional application No. 62/187,232, filed on Jun. 30, 2015.

(51) Int. Cl. B01J 13/00

(52) U.S. Cl. CPC B01J 13/0056

(57) ABSTRACT

Methods of making composite gels with stimulus-controllable permeability. Materials with stimulus-controllable permeability.

### RELATED APPLICATIONS

The present application claims priority to and benefit of applications U.S. Ser. No. 62/159,147 (filed May 8, 2015), 62/175369 (filed Jun. 14, 2015), and 62/187232 (filed Jun. 30, 2015), the entire contents of each of which are herein incorporated by reference.

### BACKGROUND

Functional materials, such as those comprising stimulus-responsive components, have many uses in areas such as energy storage, water purification, and controlled drug release. Functional materials may come in the form of gels synthesized by standard sol-gel synthesis methods.

### SUMMARY OF THE INVENTION

In certain aspects, provided are methods generally comprising the steps of: providing a colloidal dispersion of inorganic particles; providing an aqueous dispersion of stimulus-responsive particles; mixing the provided colloidal dispersion of inorganic particles with the provided aqueous dispersion of stimulus-responsive particles to form a homogeneous mixture; adding a salt solution to the homogeneous mixture; mixing the salt solution together with the homogeneous mixture; and allowing the resulting mixture to form a gel. In many embodiments, the step of allowing is performed in the absence of alcohol.

In certain aspects, provided are materials generally comprising a matrix of inorganic particles distributed throughout the material, stimulus-responsive particles dispersed within the matrix of inorganic particles, and pores between the stimulus-responsive particles and the inorganic particles.

In certain aspects, provided are methods comprising the steps of providing a material of the invention, and adjusting an environmental parameter of the material from a first condition to a second condition, thereby altering the permeability of the material.

### BRIEF DESCRIPTION OF THE DRAWINGS

The drawings are for illustration purposes only not for limitation.

FIGS. 1A, 1B, 1C, and 1D are images of composite gels comprising silica particles and PNIPAM microgels taken at different temperatures. The PNIPAM concentrations (weight %) and temperatures corresponding to each image are as follows: FIG. 1A: 0%, 40° C.; FIG. 1B: 1.4%, 40° C.; FIG. 1C: 2.1%, 40° C.; and FIG. 1D: 2.1%, 40° C. The inset from FIG. 1D shows a crack that formed in the 2.1% PNIPAM gel when the temperature was increased to 40° C.

FIG. 1E are images of 0.7% (wt) PNIPAM microgel dispersions viewed in a glass capillary at 27° C., at 32° C., and at 39° C. The opacity of the dispersion increased noticeably around and above 32° C.

FIG. 2 shows plots that illustrate a) the temperature dependence of the size of the PNIPAM microgels (curve with filled squares) and b) the temperature dependence of the permeability of silica/PNIPAM composite gels. Separate curves are plotted for the permeabilities of the composite gels of various PNIPAM concentrations (weight %): open circles, 0%; open diamonds, 1.0%; open upward-pointing triangles, 1.4%; open downward-pointing triangles 1.6%. The error bars depict the standard deviations from five different samples for the permeability measurements and from six different measurements for the microgel diameters. For clarity, the water permeability error bars are omitted for all gels except for the 0% and 1.4% PNIPAM gels.

FIG. 3 depicts a schematic drawing of the microstructure and liquid flow in composite gels of the invention comprising colloidal silica (light grey particles) and PNIPAM microgels (dark grey particles) at room temperature (approximately 25° C.; left panel) and above 32° C., the lower critical solution temperature (LCST) of PNIPAM in water. The arrows illustrate possible paths for liquid flow through the pores that exist when the PNIPAM microgels are contracted.

FIG. 4 shows the results of water permeability calculations measured from composite silica/PNIPAM gels subjected to multiple rounds of temperature changes between 25° C. (below the LCST of PNIPAM in water) and 39° C. (above the LCST of PNIPAM in water).

FIG. 5 shows plots of (absolute) water diffusion coefficients as a function of temperature, calculated for composite silica/PNIPAM gels of various concentrations.

FIG. 6 shows plots of relative water diffusion coefficients (in which the coefficients are normalized to the coefficients for the silica-only gels) as a function of temperature, calculated for composite silica/PNIPAM gels of various concentrations.

### DEFINITIONS

Certain terms are first defined below so that the present invention can be more readily understood. Additional definitions for the following terms and other terms are set forth throughout the specification.

Approximately: As used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Aqueous dispersion: The term “aqueous dispersion” refers to a dispersion in which the solvent or carrier fluid comprises water in an amount of at least 50% by weight. A purely aqueous composition comprises a carrier fluid or medium consisting essentially of water.

Biomolecules: The term “biomolecule”, as used herein, refers to a molecule (e.g., a protein, amino acid, peptide, polynucleotide, nucleotide, carbohydrate, sugar, lipid, nucleoprotein, glycoprotein, lipoprotein, steroid, etc.) whether naturally-occurring or artificially created (e.g., by synthetic or recombinant methods) that is commonly found in cells and tissues. Specific classes of biomolecules include, but are not limited to, enzymes, receptors, neurotransmitters, hormones, cytokines, cell response modifiers such as growth factors and chemotactic factors, antibodies, vaccines, haptens, toxins, interferons, ribozymes, anti-sense agents, plasmids, DNA, and RNA.

Biocompatible: As used herein, the term “biocompatible”, is intended to describe materials that do not elicit an undesirable detrimental response in vivo.

Biodegradable: As used herein, “biodegradable” polymers are polymers that degrade fully (i.e., down to monomeric species) under physiological or endosomal conditions. In some embodiments, the polymers and polymer biodegradation byproducts are biocompatible. Biodegradable polymers are not necessarily hydrolytically degradable and may require enzymatic action to fully degrade.

Colloid: As used herein, the term “colloid” is interchangeable with the phrase “colloidal dispersion” and refers to its ordinary meaning in the art, that is, a solution that has particles ranging between approximately 1 nm and approximately 1000 nm in diameter; such particles are able to remain evenly distributed throughout the solution. In a colloidal dispersion, substances remain dispersed and do not settle (e.g., to the bottom of the container), and one substance is evenly dispersed in another. The substance being dispersed is referred to as being in the dispersed phase, while the substance in which it is dispersed is in the continuous phase. Types of colloidal dispersions include sols (wherein solid particles are dispersed in a liquid solution), aerosols (wherein the particles are dispersed in a gas), and emulsions (wherein liquid particles are dispersed in a liquid solution). Aerosols may be further subdivided into fogs (liquid particles dispersed in a gas) or smokes (solid particles dispersed in a gas).

Dispersion: As used herein, the term “dispersion” refers to a mixture in which fine particles of one substance are scattered throughout another substance. Dispersions can be classified as suspensions, colloids, or solutions, according to the size of the fine particles. Generally, particles in a solution are of molecular or ionic size; those in a colloid are larger but too small to be observed with an ordinary microscope; those in a suspension can be observed under a microscope or with the naked eye. A coarse mixture (e.g., sand mixed with sugar) is usually not thought of as a dispersion.

Gel: As used herein, the term “gel” refers to a material between the solid and liquid state that consists of at least two components of which one, clearly the majority, corresponds to the liquid solvent and the other is a component that can be classified as a solid dispersed within the solvent. The solvent may be, for example, water, a salt solution, or an organic solvent. Based on a solution or a dispersion in liquid state, the formation of the gel results from partial aggregation of solid particles, forming a particle network that spans the whole volume of the sample. Typically, the gel may comprise a crosslinked network, e.g., of a polymer. Gels are typically classed as either physical gels (in which, for example, polymer chains are entangled with one another) or covalently linked gels (in which, for example, polymer chains are linked together through covalent bonds).

Hydrogel: As used herein, the term “hydrogel” refers to a polymeric material, typically a network or matrix of polymer chains, dispersed in water. A hydrogel is in a semi-solid state and typically contains at least 75%, at least 80%, at least 85%, at least 90%, or at least 95% water (by weight). The polymeric material in a hydrogel is capable of swelling in water or becoming swollen with water. Such a polymeric material that is already swollen or partially swollen with water may also be called a hydrogel. A hydrogel network or matrix may or may not be cross-linked, and cross-linked materials may be physically and/or chemically cross-linked. Hydrogels also include polymeric materials that are water swellable and/or water swelled. A hydrogel may exist in various states of hydration. In some embodiments, a hydrogel is unhydrated. In some embodiments, a hydrogel is partially hydrated. In some embodiments, a hydrogel is fully hydrated. In certain embodiments, a hydrogel may be described as being swollen with water. In certain embodiments, a hydrogel may be described as being water swellable. With reference to temperature-responsive polymers, covalently linked networks exhibit a change in their degree of swelling in response to temperature, whereas physical gels show a sol-gel transition.

Lower critical solution temperature: As used herein, the term “lower critical solution temperature,” abbreviated LCST, refers to its ordinary meaning in the art. That is, the LCST of a chemical (e.g., a polymer) in a solvent is the critical temperature point below which the chemical and the solvent are completely miscible. The LCST is sometimes also called the “cloud point” because a polymer solution below the LCST is a clear, homogeneous solution while a polymer solution above the LCST appears cloudy.

Microgel: As used herein, the term “microgel” refers to microscopic crosslinked gel particles of any shape that are dispersed in a solvent. Typically, the gel particles have an equivalent diameter (i.e., Stokes diameter) between approximately 0.1 μm (100 nm) and approximately 100 μm. In some embodiments, the solvent is water or a physiological fluid or buffer. When a microgel comprises stimulus-responsive particles, the microgel has at least two states, one state in which the solvent is a good solvent under the conditions, whereby the particles occupy a swollen state and another state, in which the solvent is a poor solvent under the conditions, whereby the particles occupy a collapsed state. Typically, the particle composition switches between the two states when conditions change such that the conditions transition from poor solvent to good solvent conditions. In either of the two states described above, a particle composition capable of such a transition may be termed a microgel.

Miscible: The term “miscible,” as used herein, refers to its ordinary meaning in the art, that is, in reference to liquids, forming a homogeneous mixture when added together.

Matrix: The term “matrix,” as used herein, refers to an aggregated nanoparticle network, e.g., of an inorganic nanoparticles. In some embodiments, the nanoparticles in the network are covalently bonded with one another. In some embodiments, the nanoparticles in the network are not covalently bonded with one another, but are associated by other means, e.g., physical interactions (such as van der Waals interactions, and/or hydrogen bonding).

Percolation: The term “percolation,” as used herein, refers to the passing of, for example, liquid through a porous material, a material with small holes, and/or a filter.

Percolation threshold: As used herein, the phrase “percolation threshold,” in reference to a porous gel, refers to a threshold below which there is no connected pathway of pores throughout the material and above which there is such a pathway through the material so as to allow liquids to percolate through the material. In reference to gels, the percolation threshold is a critical value corresponding to the concentration of particles. For example, in materials comprising stimulus-responsive particles that contract in certain environmental conditions (thereby creating pores in the material), the percolation threshold refers to the critical concentration of stimulus-responsive particles required to allow percolation through the material when the stimulus-responsive particles are contracted.

Permeability: As used herein, the term “permeability,” unless otherwise stated, refers to the state or quality of a material that causes it to allow liquids or gasses to pass through it. Unless otherwise specified, “permeability” as used herein refers specifically to the permeability of liquids; this permeability can be measured experimentally and can be expressed in SI units of m².

Polymer: The term “polymer”, as used herein, refers to a molecule of high relative molecular mass, the structure of which comprises the multiple repetition of units derived, actually or conceptually, from molecules of low relative molecular mass. Generally, “polymer” refers to a molecule comprising greater than approximately 30 units. In certain embodiments, a polymer is comprised of only one monomer species (e.g., poly(N-isopropylamide). In certain embodiments, a polymer of the present invention is a copolymer of two or more monomers.

Sol: The term “sol” is used herein according to its ordinary meaning in the art, that is, a colloidal suspension of solid particles in a liquid.

Sol-gel: As used herein, the term “sol-gel,” in reference to a process, means a method for producing solid materials from small molecules.

Stimulus-responsive: As used herein, the term “stimulus-responsive,” when used in reference to a material or a molecule (such as a polymer), refers to the ability of the material to alter at least one of its chemical or physical properties in response to the stimulus. The stimulus can be a change in any of a number of predetermined environmental parameters, such as, but not limited to, temperature, pH, light, ionic concentration, electric field, magnetic field, a chemical, a biomolecule, or any combination thereof. In many embodiments, the one or more chemical or physical properties comprise the size and/or the hydrophobicity of the material.

Temperature-responsive: As used herein, the term “temperature-responsive,” is used interchangeably with the terms “temperature-sensitive,” “heat-responsive,” “heat sensitive,” “thermoresponsive,” and “thermosensitive.” When used in reference to a material or a molecule (such as a polymer), “temperature-responsive” refers to the ability of the material to alter one or more of its chemical or physical properties in response to a change in temperature. In many embodiments, the one or more chemical or physical properties comprise the size and/or the hydrophobicity of the material.

Upper critical solution temperature (UCST): As used herein, the term “upper critical solution temperature,” abbreviated UCST, refers to its ordinary meaning in the art. That is, the UCST of a chemical (e.g., a polymer) in a solvent is the critical temperature point above which the chemical and the solvent are completely miscible.

### DETAILED DESCRIPTION OF CERTAIN EMBODIMENTS

The present invention provides, among other things, methods and compositions for stimulus-controlled permeability.

Compositions of the invention may be used, for example, as liquid flow valves. Because compositions of the present invention may be used as valves to control liquid through themselves, they may be used to deliver a liquid and/or solute dissolved in the liquid without requiring loading and unloading of the liquid or solute of interest in the material itself. These aspects offer flexibility in the type of solute that can be delivered, as well as the possibility of delivering a liquid, in a controlled manner.

Prior art methods of making composite gels with stimulus-responsive components often rely on the use of precursors that generate alcohol(s) and involve a drying step during which the alcohol(s) is/are evaporated. For example, typical sol-gel methods involve the use of an alkoxy precursor, which results in the production of alcohols that must be evaporated to produce a gel of sufficient quality (e.g., of sufficient mechanical strength to maintain structural integrity).

The present invention encompasses the recognition that the presence of alcohol during formation of a composite gel presents disadvantages in that the subsequently formed materials may be subject to deformities due to the evaporation of alcohol. Additionally, alcohol is incompatible with certain materials, such as plastics.

Accordingly, the present invention provides methods for making composite materials for stimulus-controlled permeability in which the composite material (e.g., a composite gel) is formed in the absence of alcohol. Provided methods can be used to make composite materials of any of a variety of shapes and sizes, including bulk materials, gel plugs (e.g., in tubes of any size, including as small as microcapillaries) membranes, etc. Alternatively or additionally, provided methods can be used to make composite materials that can be absorbed into a porous matrix, a fibrous material, and/or a non-woven material, which in turn can be used to make a membrane.

### Methods of Making

Provided methods typically comprise steps of providing a colloidal dispersion of inorganic particles, providing an aqueous dispersion of stimulus-responsive particles, mixing the provided colloidal dispersion of inorganic particles with the provided aqueous dispersion of stimulus-responsive particles to form a homogeneous mixture, adding a salt solution to the homogeneous mixture, mixing the salt solution together with the homogeneous mixture, and allowing the resulting mixture to form a gel.

In certain embodiments, the method further comprises a step of synthesizing the stimulus-responsive particles.

In certain embodiments, one or both steps of mixing (e.g., the step of mixing the colloidal dispersion together with the aqueous dispersion and/or the step of mixing the salt with the homogeneous mixture) comprises vortexing the components to be mixed.

In many embodiments, the step of allowing the mixture to gel is performed in the absence of any alcohol.

In some embodiments, the step of allowing the mixture to gel comprises leaving (e.g., unperturbed) the mixture from the previous step at room temperature for at least 1 hour, at least 1.5 hours, at least 2 hours, at least 4 hours, at least 24 hours, at least 48 hours, at least 72 hours, at least 96 hours, at least 120 hours, at least 144 hours, or at least 1 week.

### Compositions

In certain aspects, provided are materials whose permeability can be altered in response to one or more stimuli (e.g., a change in an environmental parameter). In certain embodiments, provided materials generally comprise a matrix of inorganic particles distributed throughout the materials, stimulus-responsive particles dispersed within the matrix of inorganic particles, and pores between the stimulus-responsive particles and the inorganic particles.

In some embodiments, the pores collectively provide one or more passageways that allow liquid to permeate through the material.

In some embodiments, the inorganic materials, when not in the matrix, are capable of forming a colloidal dispersion.

In some embodiments in which the stimulus-responsive particles comprise or consist essentially of a stimulus-responsive polymer (as further discussed herein), the stimulus-responsive polymer is not grafted onto the inorganic particles.

In some embodiments, the material is substantially free of alcohol.

In some embodiments, the pores of the material collectively provide one or more passageways that allow liquid to permeate through the material, the inorganic particles (when not in the matrix) can form a colloidal dispersion, the stimulus-responsive particles comprise a stimulus-responsive polymer, the stimulus-responsive polymer is not grafted onto the inorganic particles, and the material is substantially free of alcohol.

In many embodiments, the permeability of provided materials can be altered by changing a predetermined environmental parameter (as further discussed herein). This alteration is reversible in certain embodiments, e.g., it is possible to alter the permeability of the material more than one time and/or from a first permeability to a second permeability, and then back again to approximately the first permeability, or at least closer to the first permeability than the second permeability.

In some embodiments, the permeability of provided materials in a first condition is higher than the permeability of provided materials in a second condition. In some such embodiments, the first condition comprises a first temperature and the second condition comprises a second temperature. In some embodiments, the first temperature is higher than the second temperature. In some embodiments, the first temperature is lower than the second temperature.

For example, the permeability of some provided materials can be altered by changing the temperature to below or above a critical temperature, as further discussed herein in relation to temperature-sensitive polymers. In some embodiments, the critical temperature is close to physiological temperatures, e.g., between approximately 30° C. and approximately 42° C., inclusive of both endpoints. In some embodiments, the critical temperature is between approximately 32° C. and approximately 39° C., inclusive of both endpoints. In some embodiments, the critical temperature is between approximately 34° C. and approximately 39° C., inclusive of both endpoints.

In certain embodiments, provided are materials formed by methods of the invention.

### Methods of Altering Permeability

In certain aspects, provided are methods comprising the steps of: providing a material of the invention, adjusting an environmental parameter (e.g., temperature) of the material from a first condition to a second condition, thereby altering the permeability of the material. In some embodiments, this alteration of the permeability is reversible, e.g., further adjusting the condition from the second condition back to the first condition results in again altering the permeability of the material.

### Colloidal Dispersions of Inorganic Particles

In certain embodiments, the colloidal dispersion is a sol, e.g., the dispersed phase comprises solid particles, and the continuous phase through which the particles are dispersed is a liquid solution. Suitable liquid solutions for such sols include, but are not limited to, water and salt solutions.

The inorganic particles are typically of a size such that their largest dimension is between approximately 1 nm and approximately 1000 nm. E.g., spherical particles would have a diameter between approximately 1 nm and approximately 1000 nm.

Generally, the inorganic particles are or comprise metalloid or metallic oxides. Metalloids are elements that have properties of both non-metals and metals. Examples of metalloid elements are antimony, arsenic, born, germanium, silicon, and tellurimand. In some embodiments, the inorganic particles are or comprise metalloid oxides, suitable examples of which include antimonic acid, germanium oxide, and silicon dioxide (also known as silica). Combinations of different metalloid oxides may also be used. In some embodiments, the inorganic particles are or comprise silicon dioxide particles. In some embodiments, the inorganic particles are metal oxides, suitable examples of which include, but are not limited to, aluminum oxide, cerium dioxide (also known as ceria), molybdenum trioxide, tin oxide, titanium dioxide, tungstic oxide, vanadium oxide, vanadic acid, zirconia (zirconium oxide), and combinations thereof. Combinations including both metalloid oxides and metal oxides are also possible.

The colloidal dispersions may include elements other than the inorganic particles and the continuous phase (e.g., the liquid solution). For example, stabilizing ions may also be included.

Methods of making suitable colloidal dispersions of inorganic particles are known in the art. Some suitable colloidal dispersions of inorganic particles are readily commercially available. As non-limiting examples, suitable colloidal suspensions of silica particles are sold under the registered trademarks BINDZIL® by AkzoNobel (Bohuslan, Sweden). A series of colloidal suspensions of silica particles are sold under the registered trademark LUDOX® by Sigma Aldrich (St. Louis, Mo., United States).

### Stimuli-Responsive Particles

Generally, the stimulus-responsive particles change one or more of their physical and/or chemical properties (e.g., solubility, average particle size, etc.) in response to a small change in one or more predetermined environmental parameters, non-limiting examples of which include temperature, pH, light, ionic concentration, electric field, magnetic field, a chemical, a biomolecule, and combinations thereof. A change in the predetermined environment parameter may comprise a change in a measurable value corresponding to the parameter, including, but not limited to, the parameter itself (e.g., temperature, pH, and/or ionic concentration), the intensity and/or strength of the parameter (e.g., light, electric field, and/or magnetic field), and/or the presence or concentration of the parameter (e.g., of a chemical or a biomolecule).

The predetermined environmental parameter(s) may be chosen based on the application. In some embodiments, the permeability of the material is manipulated by deliberately exposing the material to an alteration of the predetermined environmental parameter. For example, a user of the material may deliberately change the temperature and/or pH of the material. In some embodiments, the permeability of the material is altered through the material being exposed to an environmental condition that does not result from a deliberate act, e.g., a naturally occurring change in environmental conditions. For example, a biological process (such as, for example, an infection or inflammation response) may result in the material being exposed to one or a change in pH and/or presence or altered concentration(s) of one or more chemicals or biomolecules.

In certain embodiments, the stimulus-responsive particles are formulated as microgels.

In certain embodiments, the stimulus-responsive particles comprise a stimulus-responsive polymer, i.e., a polymer that is responsive to one or more stimuli, such as one or a combination of the above-mentioned stimuli. In some embodiments, the stimulus-responsive particles consist essentially of a stimulus-responsive polymer. In some embodiments in which the stimulus-responsive particles comprise or consist essentially of a stimulus-responsive polymer, the polymer has properties such that the stimulus-responsive particles form microgels.

In certain embodiments, the stimulus-responsive polymer is responsive to temperature, pH, or both. In some embodiments, the stimulus-responsive polymer is responsive to temperature. Temperature-responsive polymers are typically characterized by a critical transition temperature at and/or around which the polymers change from one phase to another. The critical transition temperature and the nature of the phase change typically depend on the solvent in which the polymer is dispersed. A lower critical solution temperature (LCST) of a polymer, for example, refers to the temperature below which the polymer is completely miscible in the solvent in which it is dispersed. Above the LCST for a given polymer and type of solvent, the polymer is hydrophobic and in a more contracted form than below the LCST. By contrast, an upper critical solution temperature (UCST) of a polymer refers to the temperature above which the polymer is completely miscible in the solvent in which it is dispersed. Below the UCST for a given polymer and type of solvent, the polymer is hydrophobic and in a more contracted form than above the UCST. Some polymers are characterized as having a LCST, some as having an UCST, and some as having both an LCST and UCST, depending on the solvent. Any of these types of polymers are suitable for use in methods and compositions of the invention.

Accompanying the change in phase experienced upon going from one side of the LCST or UCST to another, particles such as microgels comprising temperature-responsive polymers typically change their average particle size. For example, particles comprising (a) temperature-sensitive polymer(s) with an LCST may decrease their average size if the temperature is increased from below to above the LCST. Conversely, particles comprising (a) temperature-sensitive polymer(s) with an UCST may increase their average size if the temperature is increased from below to above the UCST.

In some embodiments, the stimulus-responsive particles comprise a temperature-responsive polymer having an LCST. In some such embodiments, the polymer has an LCST in water, in physiological conditions (e.g., in a body and/or in buffers mimicking physiological conditions), and/or in an organic solvent. In some embodiments, the polymer has a LCST in water and/or in physiological conditions.

In some embodiments, the stimulus-responsive particles comprise a temperature-responsive polymer having an UCST. In some such embodiments, the polymer has an UCST in water, in physiological conditions (e.g., in a body and/or in buffers mimicking physiological conditions), and/or an organic solvent. In some embodiments, the polymer has an UCST in water and/or in physiological conditions.

The LCST and/or UCST of a temperature-responsive chemical such as a polymer is affected by the concentration of salt in the solvent.

A variety of stimulus-responsive polymers are known in the art, some of which are described, for example, in Ward and Georgiou, “Thermoresponsive Polymers for Biomedical Applications.” Polymers 2011, 3(3), 1215-1242; doi:10.3390/polym3031215. Any of these, or any combination and/or copolymer of these, may be suitable for use in methods and compositions of the invention.

For example, poly(N-alkylacrylamide)s such as poly(N-ethyl-acrylamide), poly(N,N-dimethyl-acrylamide, N,N-diethyl acrylamide), and poly(N-isopropylacrylamide) are responsive to temperature.

In some embodiments, the stimulus-responsive particles comprise poly(N-isopropylacrylamide) (hereinafter abbreviated as PNIPAM). PNIPAM has a LCST of approximately 32° C. in water. The proximity of this LCST to the temperature of typical physiological conditions (37° C.) makes PNIPAM an attractive temperature-responsive polymer for biological applications. The LCST of PNIPAM can be altered in several ways. For example, adding salt can lower its LCST. The LCST PNIPAM has also been adjusted by copolymerizing with hydrophilic or hydrophobic monomers to achieve an overall respectively higher or lower hydrophilicity. Alternatively or additionally, a desired LCST can be achieved by forming conetworks of PNIPAM and other chemicals: conetworks of PNIPAM and hydroxyethyl methacrylate (HEMA), for example, have an LCST of 34° C.

Another attractive poly(N-alkylacrylamide) is poly(N,N-diethylacrylamide) (PDEAAm), which has an LCST in the range of 25 to 32° C.

Additional temperature-responsive polymers include poly(N-alkyl-methacrylamides) (such as N-ethylmethacrylamide, poly(N-/-butylacrylamide), poly(N-methylacrylamide), and poly(N-isopropylmethacrylamide)), poly[2-(dimethylamino)ethyl methacrylate], poly(hydroxyalkylacrylates) (such as hydroxyethylacrylate), poly(hydroxyalkylmethacrylates) (such as hydroxyethylmethacrylate), poly(vinylcaprolactam), poly(vinyl methylether), polymers of partially-substituted vinylalcohols, polymers of ethylene oxide-modified benzamide, poly(N-acryloylpyrrolidone), poly(N-acryloylpiperidine), poly(N-vinylisobutyramide), poly(ethylene glycol) (also known as poly(ethylene oxide)), hydroxypropylcellulose, poloxamer 407, poloxamer 188, PLURONIC® F127 (sold by BASF, Florham Park, N.J., United States), PLURONIC® F68 (also sold by BASF), poly(organophosphazenes), and copolymers thereof.

For example, poly(N-vinylcaprolactam) (PVCL) has an LCST between approximately 25° C. and approximately 35° C., poly[2-(dimethylamino)ethyl methacrylate] (PDMAEMA) has an LCST of approximately 50° C., and poly(ethylene glycol) (PEG), also called poly(ethylene oxide) (PEO) has an LCST of approximately 85° C.

Polyethylene oxide (the typical name used for higher molecular weight PEG), polyvinylmethylether, polyhydroxylethylmethylacrylate have both a LCST and an UCST in water.

Some of the above-mentioned polymers are also know to be pH-responsive, and/or can be altered such that they are pH-responsive. For example, PNIPAM also some pH responsiveness, and can be altered with the addition of certain groups (e.g., acrylic acid, methacrylic acid or vinylacetic acid) to be even more pH-responsive.

Microgels based on copolymers of poly (N-isopropylacrylamide) and acrylic, for example, are responsive to ionic concentration.

As a non-limiting example of biomolecule-responsive particles, microgels based on copolymers of N-isopropylacrylamide and aminophenylboronic acid are responsive to glucose concentrations.

As non-limiting examples, microgels based on copolymers of poly (N-isopropylacrylamide) and chlorophyllin are responsive to light.

Non-limiting examples of particles responsive to magnetic fields include iron, nickel, cobalt, gadolinium, alloys of these metals with each other and/or with other metals, rare earth metals, certain ceramics, and ferrofluids. These particles are capable of sensing a magnetic field in that they change their orientation if needed to align with the magnetic field.

It should be noted that polymers that are described herein and/or in the art as responsive to one stimulus may also be at least somewhat responsive to one or more other stimuli and/or may be modified to be responsive to other stimuli. The responsive properties of some polymers may be tuned, for example, by modifying the polymers (such as, for example, by using other components) and/or using copolymers of monomers with different responsive properties. Examples of components that can be used to alter to the temperature-responsive properties of polymers include, but are not limited to, acrylic acid, methacrylic acid, N-vinylpyrrolidone, N,N-dimethyl aminoethylmethacrylate, oxazoline, butylmethacrylate, acrylamide, or any other vinyl or acrylic monomer which can be copolymerized with the thermosensitive monomers. Block copolymers comprising one or more hydrophilic block and/or one or more hydrophobic block may also be used in some cases. For example, block copolymers of poly(ethylene glycol) with polylactide, polyglycolide, poly(lactide-co-glycolide) (PLGA), or poly(methyl methacrylate) may be used. In some cases, the heat-sensitive polymer may be present with other polymers, for example, polymers for providing a structural matrix. Examples of such polymers include, but are not limited to, poly(ethylene glycol), polylactide, polyglycolide, poly(methyl methacrylate), or the like. For instance, the two polymers may be present as a polymer blend, a co-polymer, or as interpenetrating polymers.

In certain embodiments, the stimulus-responsive particles comprise a stimulus-responsive polymer that is biodegradable. For example, biodegradable versions of known stimulus-responsive polymer can be prepared by incorporating cleavable groups into the polymer. For example, Xiao et al. prepared a biodegradable hydrogel by preparing a version of PNIPAM with cleavable lactic acid and dextran groups (Xiao, H.; Nayak, B. R.; Lowe, T. L. Synthesis and characterization of novel thermoresponsive-cobiodegradable hydrogels composed of N-isopropylacrylamide, poly(L-lactic acid), and dextran, J. Polym. Sci. Part A 2004, 42, 5054-5066).

### Salt Solutions

Salt solutions suitable for use in accordance with the invention include solutions of monovalent cations are preferred, e.g., monovalent cation solutions of sodium, potassium, lithium, rubidium, cesium, or silver. Salts such as ammoniumbicarbonate or those including hydrogen ions can also be used. Generally, monovalent salts should be are used with a concentration between approximately 0.3 and approximately 2 M. Solutions of some divalent salts (e.g., of beryllium, calcium, magnesium, strontium, barium, or any of the transition metal salts that are divalently charged) can also be used. Generally, when a salt with a divalent charge is used, smaller salt concentrations are needed to gel the sample, for example, less than 0.3M but more than 10⁻⁵M. Suitable anions include, but are not limited to, chlorides, carbonates, bicarbonates, sulfates, nitrates, nitrite, phosphates, hydroxides, fluorides, etc.

In some embodiments, the salt solution is a solution of NaCl. In some methods of the invention, the step of adding a salt solution comprises adding NaCl to a final concentration of NaCl between approximately 0.3 M to 2 M NaCl, between approximately 0.3 M to 1 M, or to approximately 0.5 M.

### EXAMPLES

The following examples describe some of the modes of making an practicing the present invention. However, it should be understood that these examples are for illustrative purposes only and are not meant to limit the scope of the invention. Furthermore, unless the description in an Example is presented in the past tense, the text, like the rest of the specification, is not intended to suggest that experiments were actually performed or data were actually obtained.

### Example 1

### Preparation and Characterization of Poly(N-Isopropylacrylamide) Microgels

The present Example demonstrates the preparation and characterization of microgels of a temperature-sensitive polymer, poly(N-isopropylacrylamide) (PNIPAM). These microgels can be used to make composite materials for temperature-controlled permeability.

### Materials and Methods

Sodium chloride N-isopropylacrylamide, N,N-methylenebisacrylamide, and ammonium persulfate were purchased from Sigma-Aldrich (Stockholm, Sweden).

Synthesis and Characterization of poly(n-isopropylacrylamide) Microgels

Typically, 1.35 g N-isopropylacrylamide and 0.08 g methylenebisacrylamide were dissolved in 150 mL of water (Millipore MilliQ, 18 MQ cm) and transferred to a 500 mL round-bottomed three-neck flask. After heating the mixture to 70° C. under magnetic stirring, the mixture was purged with nitrogen gas for 30 minutes. Ammonium persulfate (0.1 g) dissolved in 5 mL of water was slowly injected drop-wise into the flask. The reaction mixture was stirred for 4 hours at 70° C. and cooled to room temperature. Dialysis was then performed against deionized water until there was no change in conductivity. The dialyzed 0.7% (wt) PNIPAM microgel dispersion was concentrated by ultracentrifugation at 14,000 rotations per minute (RPM) in an Optima XL-100K ultracentrifuge (Beckman Coulter, Palo Alto, Calif., USA) with a Type 90 Ti fixed angle rotor for 2.5 hours, yielding a 6.0% (wt) PNIPAM sediment as determined by weighing the dry weight content after drying overnight at 80° C.

A 0.7% (wt) PNIPAM aqueous dispersion in a glass capillary was imaged in an MP70 Melting Point System (Mettler Toledo AG, Schwerzenbach, Switzerland) at different temperatures, including 27° C., 32° C., and 39° C. The average diameter of the microgel particles was measured in 0.01-0.12% (wt) aqueous dispersions at different temperatures by dynamic light scattering (DLS) (Zetapals, Brookhaven Instruments Corporation, Holtsville, N.Y., USA) by averaging six separate measurements at each temperature. After temperature adjustment, the sample was allowed to temperature equilibrate in the instrument for 20 minutes.

### Results

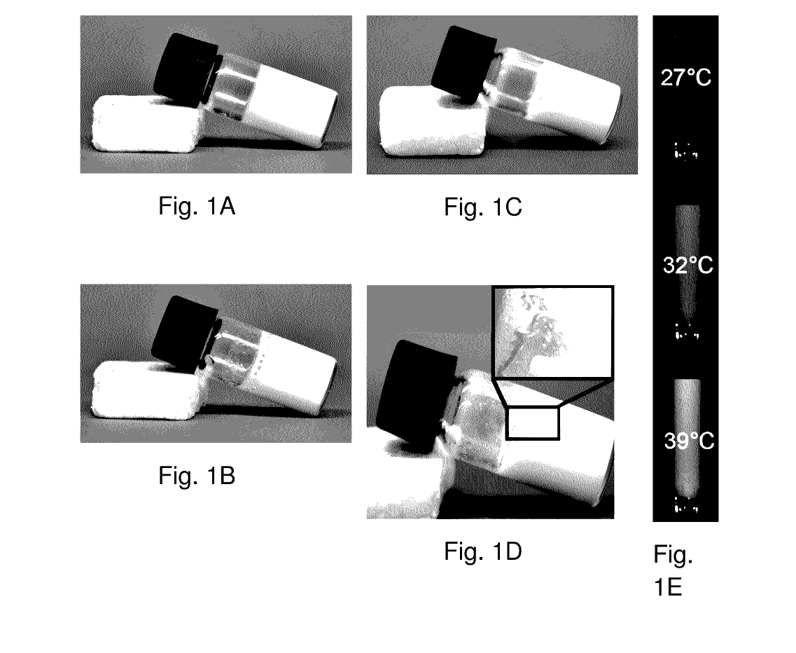

The aqueous PNIPAM dispersion was observed to be more opaque at higher temperatures; the sample was more opaque at 32° C. than at 27° C. and even more opaque at 39° C. than at 32° C. (FIG. 1E). Without wishing to be bound by any particular theory, this temperature-dependent opacity is due to increased scattering of visible light at and above the LCST, which results from a change in the hydrophobicity of PNIPAM. At around 32° C., the hydrophobicity increased to the point where the microgels expelled most of their water content.

The average gel diameters at 25° C. and 39° C. were 782 and 299 nm, respectively, which corresponds to a 94.4% reduction in the average microgel sphere volume. Hypothetically, in the context of a composite material comprising the PNIPAM microgels and a matrix of other particles, this reduction in volume would open up a 483 nm pore space for liquid flow between the matrix of other particles and the contracted PNIPAM microgel.

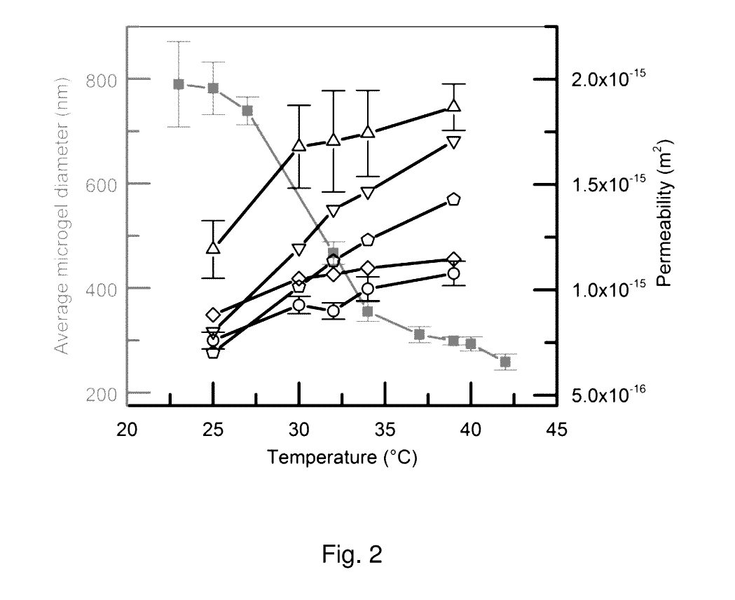

FIG. 2 shows the observed relationship between temperature and average PNIPAM microgel diameter (curve with filled squares). As shown in FIG. 2, the transition temperature, also called the lower critical solution temperature in this case, for the PNIPAM microgels, was around 32° C.

### Example 2

### Obtainment and Characterization of Silica Nanoparticles

The present Example describes a suitable temperature-insensitive material that may be used together with a temperature-sensitive material to generate composite materials for temperature-controlled permeability.

An aqueous colloidal silica dispersion (50% (wt) silica), sold under the trademark BINDZIL®, was obtained from AkzoNobel Pulp and Performance Chemicals (Bohus, Sweden). The density of the silica particles was 2.2 g/cm³.

To determine silica particle sizes, DLS (Malvern Zetasizer Nano ZS, Malvern Instruments, Southborough, UK) was performed on a 0.1% (wt) BINDZIL® 50/80 silica dispersion at 23° C. The observed average silica particle diameter was 63 nm, with a standard deviation of 20 nm.

### Example 3

### Preparation and Characterization of Composite Materials

The present Example demonstrates a sol-gel method of preparing composite PNIPAM/silica materials that can be used for temperature-controlled liquid permeability. Such materials are also characterized in this Example.

### Materials and Methods

The silica dispersion obtained and characterized as described in Example 2 was mixed with the concentrated 6% (wt) PNIPAM microgel sediment prepared and characterized as described in Example 1 by vortexing at room temperature (approximately 25° C.) for 15 seconds, i.e., until the sample appeared by the naked eye to be homogeneous. NaCl solution was then added to all samples to a final concentration of 0.5 M; then the samples were mixed by vortexing again for 15 seconds, again at room temperature (approximately 25° C.). All samples in this Example had a set silica concentration of 22% (wt) (10% (vol.)) and 0.5 M NaCl. In one set of samples, the PNIPAM microgels were omitted; these samples became the silica-only gels used for comparisons with the PNIPAM-containing samples. The concentrations of the PNIPAM microgels in the other samples varied and were 1.0%, 1.4%, or 1.6% (wt).

The sample mixture was then transferred to 1.5 mL glass vials, 5 mm NMR tubes, or liquid permeability columns (as described herein in Example 3), where the mixtures were left to gel. The phase behavior was characterized by visual inspection and inverted tube tests on samples that had been left to gel for a week. Inverted tube tests were performed on samples as follows: 1.5 mL glass vials containing the samples were inverted approximately 180 degrees such that the openings of the glass tubes were facing downward. Samples that readily flowed when the vials were inverted (i.e., were observed by the naked human eye to flow within 5 seconds of inversion) were defined as liquids; those that did not were defined as gels. (This test is henceforth referred to as the inverted tube test.)

The composite gels were imaged at room temperature (23° C.) and at 40° C. using with a camera (Nikon D3200, Nikon Corp. with a Nikon AF-S 40 mm f/2.8 G objective). (To bring the samples to 40° C. for imaging, the samples were heated for 10 minutes in a temperature-controlled water bath. To bring the samples to 23° C. for imaging, the samples were left to cool at the lab bench.)

### Results

FIGS. 1A-D show composite silica/PNIPAM gels with different PNIPAM microgel concentrations ranging between 0 and 2.1%. The samples shown in FIGS. 1A-D had gelled in about 1-1.5 hours (as judged by an inverted tube test). It was observed, based on this and other experiments performed by the present inventors, that the silica and salt concentrations were the main factors determining gellation times. The mechanical stability of the gels was observed to improve by letting the samples gel for one week before performing inverted tube tests or permeability experiments. Without wishing to be bound by any particular theory, this improvement is attributed to Oswald ripening, which re-deposits dissolved silica at the contact points between the silica particles.

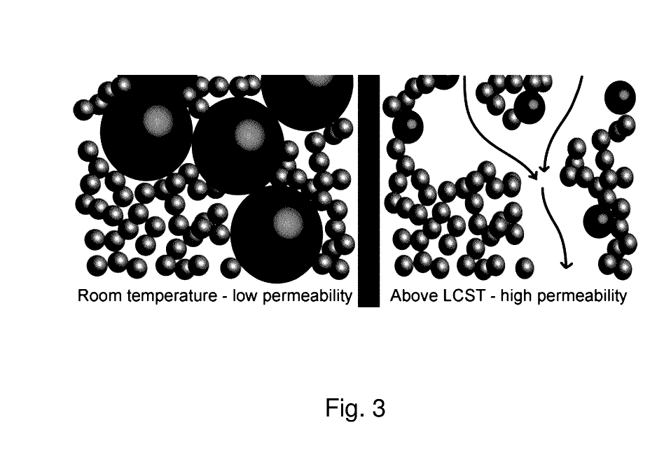

FIG. 3 is a conceptual illustration of the final structure of the composite silica/PNIPAM material after gellation, in which the PNIPAM microgels are locked into place within a colloidal silica matrix. At 25° C., all gels shown in FIG. 1A-D had a macroscopic homogenous opaque white appearance. The appearance and mechanical integrity of the gels remained when the temperature was raised to 40° C. for all gels except for the gel with 2.1% (wt) PNIPAM, which developed millimeter-sized cracks in the interface between the glass wall of the vial and the gel (see FIG. 1D-inset). The same temperature change (25° C. to 40° C.) in a composite gel with 3.27% (wt) PNIPAM resulted in shrinkage and collapse of the entire gel (data not shown). Hence, in this type of composite material, a PNIPAM concentration of around 1.8% (wt) was the upper limit that allowed the composite gels to withstand the temperature-induced microgel contractions.

### Example 4

### Temperature-Controlled Permeability Using Composite Materials

The present Example demonstrates that liquid permeability in PNIPAM/silica composite materials of the invention can be modulated by changes in temperature and that permeability is also affected by the concentration of PNIPAM microgels in the material.

### Materials and Methods

### Permeability Measurements

Liquid permeability columns were constructed as previously described (Abrahamsson et al. Magnetically-induced structural anisotropy in binary colloidal gels and its effect on diffusion and pressure driven permeability. Soft Matter 10, 4403-4412 (2014), the entire contents of which are herein incorporated by reference.) In brief, the bottom of a 5-mm-diameter glass NMR tube was removed. To provide support for a gel plug (described below), a 210-micron polyester mesh was glued to one of the openings of the tube. The same end of the tube was then sealed with parafilm.

Composite gels were prepared according to Example 2, with the sample solution being poured into the liquid permeability columns up to a height of 30 mm from the mesh. The other end of the tube (opposite to that of the mesh) was sealed with parafilm. After letting the gel plugs rests for 1 week, the parafilm was removed and the columns were fixed upright in a stand over a beaker filled with 0.5 M NaCl solution on top of the gel plug, effectively creating a pressure gradient over the gel plug.

In the beaker, the NaCl solution level was adjusted to match the top of the gel plugs. The top position of the NaCl solution in the columns was monitored twice a day for at least three days by marking the columns with a marker pen. Temperatures were adjusted according to the experiment, as further described below. After each temperature change, the columns were refilled with NaCl solution, and the procedure was repeated. The flow speed was close to linear for the first week in all samples, and the results were used to calculate the liquid permeability using Darcy's law:

$$v = - K \frac{d h}{d l} , \qquad ( Equation 1 )$$

where v is the measured flow speed, K, is the hydraulic conductivity, h is the hydraulic head, and l is the flow path length (e.g., thickness of the gel plug in this case).

Darcy's law can also be written as:

$$v = - \frac{k ρ g}{μ} \cdot \frac{d h}{d l} A , \qquad ( Equation 2 )$$

where k is the permeability (the values of which are being estimated using this equation and the measured v values), ρ is the density of the solution (e.g., the salt solution in this case), g is the gravitational acceleration, μ is the dynamic viscosity of water, and A is the cross-sectional area through which the solution is being flowed.

### Temperature Modulation

Composite PNIPAM/silica gels of varying PNIPAM microgel concentrations (0%, 1%, 1.4%, 1.6%, and 1.8% (all weight percentages)) were placed in a beaker in a controlled-temperature water bath. The temperature of the water bath was checked with a thermometer. In this experiment, the liquid permeabilities in the same set of composite gel samples was measured at 25° C., 30° C., 32° C., 34° C., and 39° C. in that order. For each temperature, the system was allowed to equilibrate to the set temperature for half an hour before the permeability measurements were conducted.

### Results

As shown in FIG. 2, both the temperature and the microgel size affected the water permeability of the composite materials. When the temperature was increased, the permeability increased, consistent with the contraction of PNIPAM microgels observed at higher temperatures. (See Example 1 for a discussion of PNIPAM diameters.) This effect was already significant between 25° C. and 30° C., the latter of which is several degrees below the lower critical solution temperature of 32° C. The permeability increased with increasing temperature also in the pure silica (0% PNIPAM) gels. Without wishing to be bound by any particular theory, it is possible that part of the increase was due to viscosity changes in the permeating liquid.

### Example 5

### Repeated and Reversible Temperature-Induced Changes in Permeability of PNIPAM/Silica Composite Materials

In the present Example illustrates, composite materials of the invention were used as liquid flow valves to reversibly adjust the flow of liquids through them. Multiple rounds of temperature-induced permeability changes were shown to be possible in the same sample.

### Materials and Methods

PNIPAM/silica composite sol gels were prepared as described in Example 3. Liquid permeability measurements were conducted as described in Example 4.

### Temperature Modulation

The temperature of the system was adjusted repeatedly between 25° C. (below the lower critical solution temperature of PNIPAM) and 39° C. (above the lower critical solution temperature of PNIPAM). After each temperature adjustment, the system was allowed to equilibrate for half an hour before permeability experiments were performed. A total of six temperature adjustments (after an initial permeability experiment performed at 25° C.) were used in this experiment, resulting in a total of seven sets of permeability measurements on the same composite gel samples.

### Results

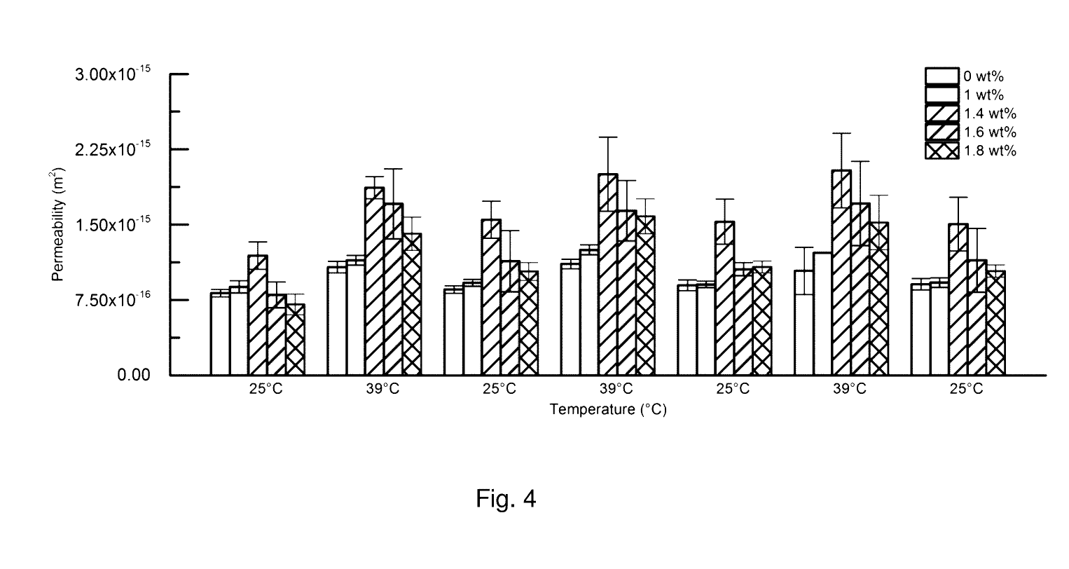

FIG. 4 shows the calculated permeabilities for three cycles of temperature changes from 25° C. to 39° C. and for an additional change back again to 25° C. In the pure silica gels (0% PNIPAM), the permeability increased by 32% the first time the temperature was increased from 25° C. to 39° C. The corresponding changes during the first temperature cycle (going from 25° C. to 39° C.) in the composite gels with 1, 1.4, 1.6 and 1.8% (wt) PNIPAM were permeability increases of approximately 30%, 57%, 113%, and 61%, respectively.

Permeability increases were also observed during the second and third temperature cycles. For all concentrations of PNIPAM tested, the permeabilities measured at 39° C. during the second and third cycles were comparable to the permeabilities measured at 39° C. during the first cycle. However, there was a noticeable increase in the permeabilities measured at 25° C. in the second cycle compared to those measured at 25° C. in the first cycle; for the 0%, 1.4%, 1.6%, and 1.8% (wt) PNIPAM composite gels, this increase was greater than the standard deviation of the average permeability measurement at 25° C. for the first cycle.

Thus, the percentage increases in permeability observed when the temperature was increased from 25° C. to 39° C. were not as great during the second and third temperature cycles as they were during the first temperature cycle. During the second temperature cycle, the permeabilities increased approximately 30%, 36%, 29%, 44%, and 97% for the composite gels with 0% 1%, 1.4%, 1.6%, and 1.8% (wt) PNIPAM, respectively, when the temperature was increased from 25° C. to 39° C. The corresponding permeability increases during the third cycle were 16%, 35%, 33%, 62%, and 41% for the composite gels with 0% 1%, 1.4%, 1.6%, and 1.8% (wt) PNIPAM, respectively.

These results show that the temperature-induced permeability changes were at least partially reversible: it was possible to alter the permeability of the material repeatedly between a lower and a higher permeability value, with approximately the same magnitude of higher permeability achieved during the second and third temperature cycles as achieved during the first cycle. However, the largest relative (percentage) changes in permeabilities occurred during the first temperature cycle, suggesting that some irreversible changes occurred during that cycle. Without wishing to be bound by any particular theory, possible causes for the irreversible changes include loss of microgels at the surfaces of the gels and/or misalignment of the microgels within the pores as they shrink and re-swell, leaving small pores next to the microgels even in their swelled state. Although it is possible that formation of microcracks could contribute to irreversible changes in the microgels, no cracks were observed in the samples used in this experiment, and the gels remained mechanically strong during the entirety of the permeability measurements.

The gel with 1.4% (wt) PNIPAM displayed the largest absolute change in permeability, while the gel with 1.6% (wt) PNIPAM displayed the largest relative change in permeability. These results suggest that the percolation threshold for a connected pore space was reached at around these concentrations of PNIPAM, allowing for a continuous flow through the whole sample volume.

### Example 6

### NMR Measurements of Diffusion

To explore possible mechanisms underlying the observed temperature-induced changes described in Examples 4 and 5, diffusion coefficients through the PNIPAM/silica composite gels were measured.

### Materials and Methods

NMR experiments were performed on a Bruker Avance 600 spectrometer (Bruker, Karlsruhe, Germany) with a diffusion probe with a maximum gradient strength of 1200 G/cm and with a 5 mm RF insert with 1H and 2H coils. All diffusion experiments were performed with Δ=500 ms, δ=1 ms, and the gradient strength, g, linearly ramped in 17 steps from 0 to 30.03 G/cm in the conventional stimulated-echo sequence. Relaxation delay, D1, was set to 20 s, and each experiment comprised a collection of 16 acquisitions. All measurements were made at 23° C.

### Results

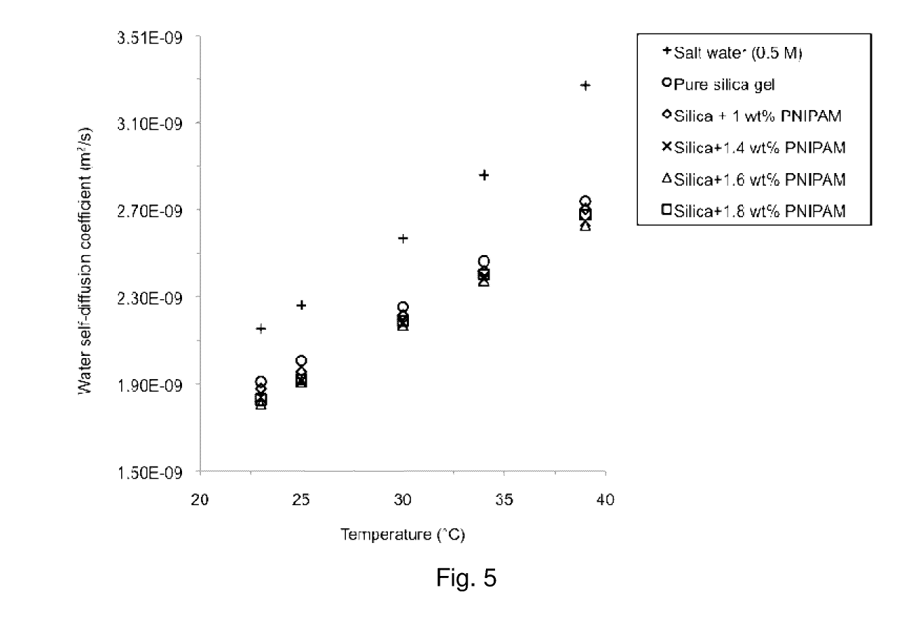

As shown in FIG. 5, there was a temperature-dependent increase in the water diffusion coefficient. This effect was observed in all samples tested: the composite gels having various PNIPAM concentrations, the silica-only gels, and the salt buffer alone (0.5 M NaCl).

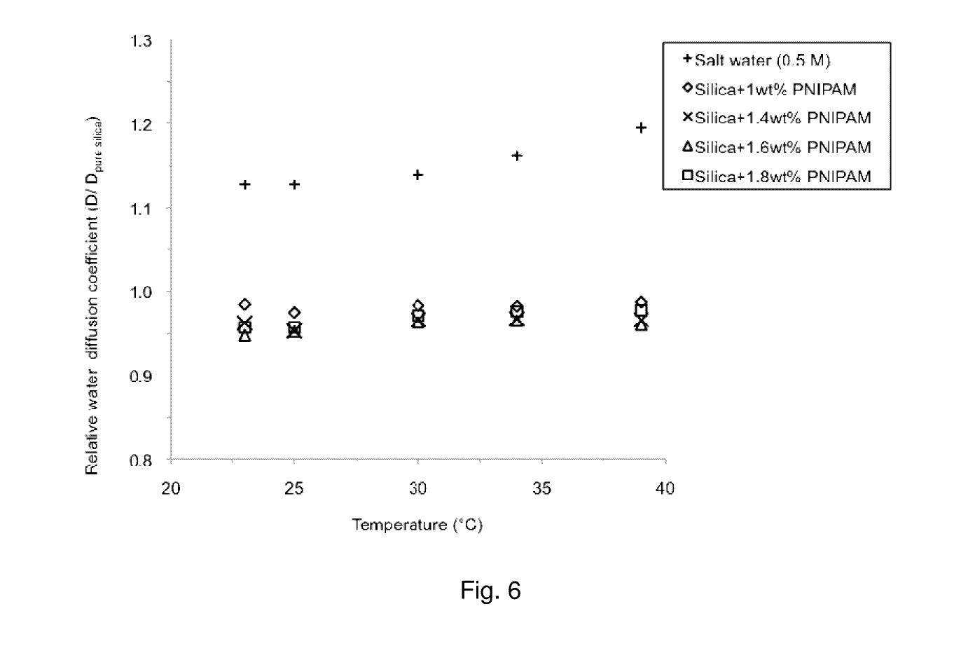

The diffusion coefficients were also calculated relative to the diffusion coefficients of the silica-only gels (no PNIPAM). As shown in FIG. 6, there was no increase in the relative diffusion coefficient with increasing temperature. Thus, it appears that the contraction of the microgels between 25° C. and 40° C. did not in itself appear to affect the water diffusion.

The relative diffusion coefficients for the PNIPAM-containing gels were less than 1.0 (FIG. 6), indicating that the presence of PNIPAM in the gels caused a decrease in the diffusion coefficient.

These results suggest that the diffusion rate depends on the temperature and amount of solid material, not on the material's microstructure. These results may be understood in the context of Zhang and Wu's studies (“Temperature and pH-responsive polymeric composite membranes for controlled delivery of proteins and peptides.” Biomaterials 25, 5281-5291 (2004), the entire contents of which are herein incorporated by reference), which found that the permeability of small molecules through polymer films containing dispersed microgels was the same whether the microgels were contracted or swollen, whereas the permeability of larger molecules differed significantly.

Without wishing to be bound by any particular theory, it is suggested that the relative water diffusion decreased in all gels because of the obstruction effect and that the surface charge of the silica particles and the microgel polymer network bind water and effectively slow down water diffusion.

### INCORPORATION OF REFERENCES

All publications and patent documents cited in this application are incorporated by reference in their entirety to the same extent as if the contents of each individual publication or patent document were incorporated herein.

1. A method comprising the steps of:
(a) providing a colloidal dispersion of inorganic particles;
(b) providing an aqueous dispersion of stimulus-responsive particles;
(c) mixing the provided colloidal dispersion of inorganic particles with the provided aqueous dispersion of stimulus-responsive particles to form a homogeneous mixture;
(d) adding a salt solution to the homogeneous mixture;
(e) mixing the salt solution together with the homogeneous mixture; and
(f) allowing the mixture resulting from step (e) to form a gel.

2. The method of claim 1, wherein the stimulus-responsive particles are formulated as microgels.

3-4. (canceled)

5. The method of claim 1, wherein step (f) is performed in the absence of any alcohol.

6. (canceled)

7. The method of claim 1, wherein the stimulus-responsive particles comprise a stimulus-responsive polymer.

8. (canceled)

9. The method of claim 7, wherein the stimulus-responsive polymer is in the form of a microgel.

10. The method of claim 9, wherein the stimulus-responsive polymer is responsive to a predetermined environmental parameter selected from the group consisting of temperature, pH, light, ionic concentration, electric field, magnetic field, a chemical, a biomolecule, and combinations thereof.

11. The method of claim 10, wherein the predetermined environmental parameter is temperature.

12. The method of claim 11, wherein the stimulus-responsive polymer has a lower critical solution temperature in water, physiological conditions, and/or an organic solvent.

13-15. (canceled)

16. The method of claim 11, wherein the stimulus-responsive polymer has both a lower and an upper critical solution temperature in water, physiological conditions, and/or an organic solvent.

17. (canceled)

18. The method of claim 7, wherein the stimulus-responsive polymer is biodegradable.

19. The method of claim 7, wherein the stimulus-responsive polymer is selected from the group consisting of poly(N-alkylacrylamide)s, poly(N-alkyl-methacrylamide)s, poly[2-(dimethylamino)ethyl methacrylate], poly(hydroxyalkylacrylate)s, poly(hydroxyalkylmethacrylate)s, poly(vinylcaprolactam), poly(vinyl methylether), polymers of partially-substituted vinylalcohols, polymers of ethylene oxide-modified benzamide, poly(N-acryloylpyrrolidone), poly(N-acryloylpiperidine), poly(N-vinylisobutyramide), poly(ethylene glycol) (also known as poly(ethylene oxide)), hydroxypropylcellulose, poloxamer 407, poloxamer 188, PLURONIC® F127, PLURONIC® F68, poly(organophosphazenes), and copolymers thereof.

20. The method of claim 19, wherein the stimulus-responsive polymer is a poly(N-alkylacrylamide).

21. The method of claim 20, wherein the poly(N-alkylacrylamide) is selected from the group consisting of poly(N-ethyl-acrylamide), poly(N,N-dimethyl-acrylamide, N,N-diethyl acrylamide), and poly(N-isopropylacrylamide).

22. The method of claim 21, wherein the poly(N-alkylacrylamide) is poly)N-isopropylacrylamide).

23. The method of claim 1, wherein the inorganic particles comprise a metalloid oxide, a metal oxide, or combinations thereof.

24. The method of claim 23, wherein the inorganic particles comprise a metalloid oxide.

25. The method of claim 24, wherein the metalloid oxide is selected from the group consisting of antimonic acid, germanium oxide, silicon dioxide, and combinations thereof.

26. The method of claim 25, wherein the metalloid oxide is silicon dioxide.

27-33. (canceled)

34. A material comprising:
a matrix of inorganic particles distributed throughout the material,
stimulus-responsive particles dispersed within the matrix of inorganic particles, and pores between the stimulus-responsive particles and the inorganic particles.

35-75. (canceled)

76. A method comprising the steps of:
providing a material of claim 34 or 59, and
adjusting an environmental parameter of the material from a first condition to a second condition, thereby altering the permeability of the material.

77-78. (canceled)
